(19) United States
(12) Patent Application Publication
(10) Pub. No.: US 2010/0039374 A1
(43) Pub. Date: Feb. 18, 2010

(54) ELECTRONIC DEVICE AND METHOD FOR VIEWING DISPLAYABLE MEDIAS

(75) Inventors: Xiao-Guang Li, Shenzhen City (CN); Chia-Yu Cheng, Tu-Cheng (TW); Jui-Lin Ke, Tu-Chen (TW); Kuan-Hong Hsieh, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD, Tu Cheng (TW)

(21) Appl. No.: 12/421,627

(22) Filed: Apr. 9, 2009

(30) Foreign Application Priority Data
Aug. 14, 2008 (CN) 200810303789.2

(51) Int. Cl. G09G 5/00

(52) U.S. Cl. 345/156

(57) ABSTRACT

A method adapted for an electronic device for viewing medias is provided. The method includes: detecting a motion of an electronic device; determining the motion of the electronic device is a first two control motion or a second two control motion; controlling a display unit to display a previous media or a next media if the motion of the electronic device is the first two control motion; controlling the display unit to display a media of a previous album or a next album if the motion of the electronic device is the second two control motion.

### RELATED APPLICATIONS

This application is related to a co-pending U.S. patent application filed concurrently herewith whose Attorney Docket No is US 20395 and entitled “ELECTRONIC DEVICE AND METHOD FOR VIEWING DISPLAYABLE MEDIAS,” which is incorporated herein in its entirety by reference.

### BACKGROUND

1. Technical Field

The disclosure relates to electronic devices and, particularly, to an electronic device capable of viewing displayable medias and a method thereof.

2. Description of Related Art

Nowadays, many electronic devices, e.g., mobile phones, digital photo frames, electronic readers (e-reader), are capable of storing and displaying electronic documents (e.g., digital pictures, digital texts, etc). Usually, electronic documents are stored in a file. For example, a file can be an album including a plurality of digital pictures. When viewing pictures in an album, if a user wants to view another album, the user must finish paging through the remaining pictures in the present album first, or return to the operation menu and enter the commands to select and open another album, which is inconvenient and time consuming.

Therefore, it is necessary to provide an electronic device and a method to overcome the above-identified deficiencies.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of an electronic device in accordance with an exemplary embodiment.

FIG. 2 is a schematic diagram illustrating recognized control motions of the electronic device of FIG. 1 in accordance with a first exemplary embodiment.

FIG. 3 is a schematic diagram illustrating recognized control motions of the electronic device of FIG. 1 in accordance with a second exemplary embodiment.

FIG. 4 is a flowchart illustrating a method for viewing pictures applied in the electronic device of FIG. 1, in accordance with an exemplary embodiment.

### DETAILED DESCRIPTION

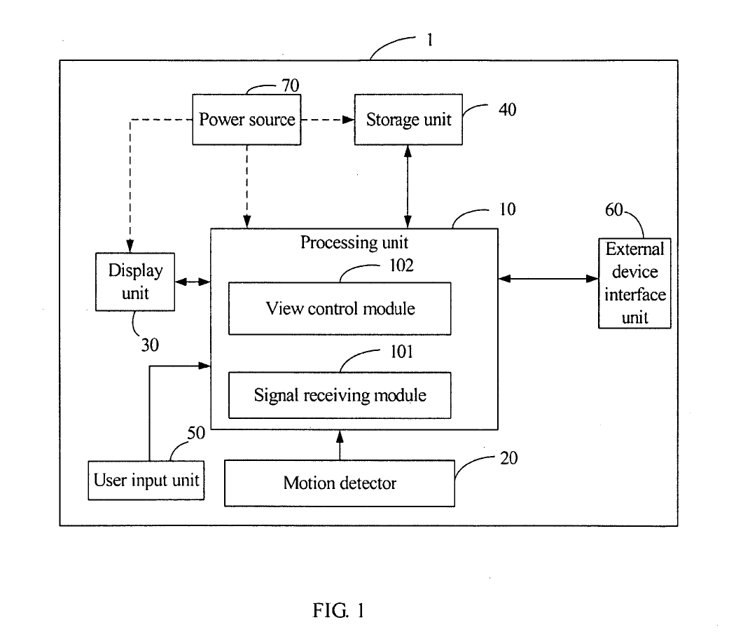

Referring to FIG. 1, an electronic device 1 includes a processing unit 10, a motion detector 20, a display unit 30, a storage unit 40, a user input unit 50, an external device interface unit 60 such as an input port or wireless transceiver, and a power source 70.

The interface unit 60 is configured to connect to an external electronic device (not shown). The external device can be a storage card (for example, a secure digital (SD) card, a compact flash (CF) card) or another electronic device (for example, a digital camera, a mobile phone, or a computer).

The user input unit 50 is configured to generate instructions in response to user operations. The user input unit 50 can be an input key (e.g., button), a knob, and the like. The power source 70 is configured to provide power to elements of the electronic device 1, such as the processing unit 10 and the display unit 30.

The storage unit 40 is configured to store displayable media such as digital pictures. The display unit 30 is configured to display the media. In the embodiments, digital pictures (hereinafter pictures) are used as an example to illustrate the present device and method. Further, a file containing a plurality of pictures is referred to as an album.

The motion detector 20 is configured for detecting and differentiating motions of the electronic device and producing corresponding motion signals indicating the motions of the electronic device 1. Specifically, the motion detector 20 is configured to recognize pre-determined control motions. When a pre-determined control motion is detected, a function command that is associated with that motion will be activated. For example, in this embodiment, the motion detector 20 is capable of detecting rotation and direction of rotation of the electronic device 1 which can be associated with view next picture and view previous picture commands in a picture viewing mode or view next album and view previous album in an album viewing mode. In the exemplary embodiment, the motion detector 20 can be an accelerometer.

The processing unit 10 includes a signal receiving module 101 and a view control module 102.

The signal receiving module 101 is configured for receiving the motion signals produced by the motion detector 20. The view control module 102 is configured for determining the motion of the electronic device 1 according to the motion signals and controlling which picture from which album is displayed according to the motion of the electronic device 1.

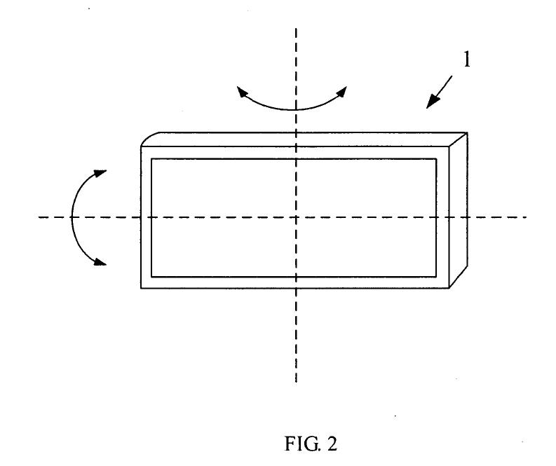

Referring also to FIG. 2, The pre-determined control motions will be described assuming an orientation of the electronic device 1 is initially right-side up and facing a user before each control motion is executed by the user. In this embodiment there are four control motions. The first two control motions are rotation about a vertical axis of the electronic device 1, and the last/second two control motions are rotation about a horizontal axis of the electronic device 1. The first control motion is rotate the electronic device 1 towards user's right which causes the next picture to be displayed, and the second control motion is rotate the electronic device 1 toward user's left which causes the previous picture to be displayed. The third control motion is rotate top of the electronic device 1 away from user to view a picture from the next album and the fourth control motion is rotate top of the device 1 toward user to view picture from previous album. Accordingly, the view control module 102 determines a motion of the electronic device 1 according to the motion signals from the motion detector 20 and controls which picture from which album is displayed according to the motion of the electronic device 1.

In detail, if the view control module 102 determines the motion of the electronic device 1 is the first control motion, the view control module 102 controls the display unit 30 to display the next picture; and if the view control module 102 determines the motion of the electronic device 1 is the second control motion, the view control module 102 controls the display unit 30 to display the previous picture.

If the view control module 102 determines that the motion of the electronic device 1 is the third control motion, the view control module 102 controls the display unit 30 to display a picture in the next album; and if the view control module 102 determines that the motion of the electronic device 1 is the fourth control motion, the view control module 102 controls the display unit 30 to display a picture in the previous album. In the exemplary embodiment, the view control module 102 controls the display unit 30 to display a first picture of the previous album or the next album when the motion of the electronic device is the second two control motion.

In another exemplary embodiment, the view control module 102 controls the display unit 30 to display a picture of a next album or a previous album if the electronic device is rotated about a horizontal axis of the electronic device 1, and controls the display unit 30 to display a next picture or a previous picture if the electronic device 1 is rotated about a vertical axis of the electronic device 1. In further another exemplary embodiment, the view control module 102 controls the display unit 30 to display a random picture of the previous album or the next album when the motion of the electronic device is the last two control motion.

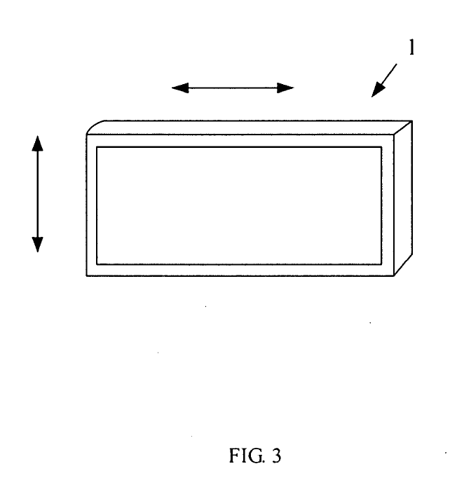

Referring to FIG. 3, in the second exemplary embodiment, the first two control motions including the first control motion and the second control motion are respectively a sudden short movement of the electronic device 1 from right to left, which can be accomplished by a user flicking their wrist right or left correspondingly, for example, along the horizontal axis, and a sudden short movement from left to right along the horizontal axis, the second two control motions including a third control motion and a fourth control motion are respectively a sudden short movement of the electronic device 1 from down to up along the vertical axis and a sudden short movement of the electronic device from up to down along the vertical axis. As described in the exemplary embodiment, if the motion of the electronic device 1 is the first control motion or the second control motion, the view control module 102 controls the display unit 30 to display the next picture or the previous picture. If the motion of the electronic device 1 is the third control motion or the fourth control motion, the view control module 102 controls the display unit 30 to display a picture of the next album or the previous album.

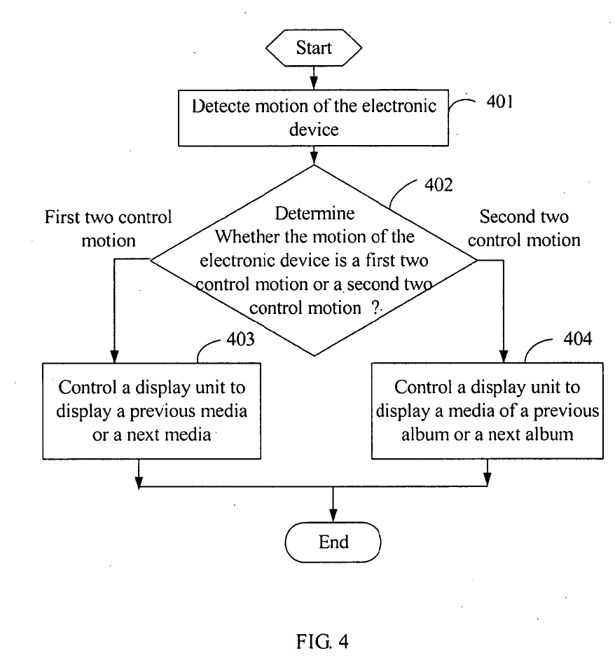

FIG. 4 is a flowchart illustrating a method for view pictures applied in the electronic device 1 in accordance with an exemplary embodiment. In step S401, the motion detector 20 detects the control motions of the electronic device 1 and produces corresponding motion signals.

In step S402, the signal receiving module 101 receives the motion signals and the view control module 102 determines control motions of the electronic device 1 executed by the user according to the motion signals.

If the motion of the electronic device 1 is the first two control motion, in step S403, the view control module 102 controls the display unit 30 to display a next picture or a previous picture. For example, if the electronic device 1 is rotated toward user's right, the view control module 102 controls the display unit 30 to display the next picture, and if electronic device 1 is rotated toward user's left, the view control module 102 controls the display unit 30 to display the previous picture.

If the motion of the electronic device 1 is the second two control motion, in step S404, the view control module 102 controls the display unit 30 to display a picture of a next album or a picture of a previous album. For example, if top of the electronic device 1 is rotated away from user about horizontal axis, the view control module 102 controls the display unit 30 to display a picture of the next album, if top of the electronic device 1 is rotated toward user about the horizontal axis of the electronic device, the view control module 102 controls the display unit 30 to display a picture of the previous album.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An electronic device comprising:
a processing unit;
a storage unit storing displayable media contained in two or more albums;
a display unit configured for displaying the media;
a motion detector configured for detecting and differentiating motions of the electronic device and producing corresponding motion signals;
wherein the processing unit comprises:
a signal receiving module configured for receiving the motion signals produced by the motion detector; and
a view control module configured for controlling the display unit to display media according to the motion signals; each motion signal is associated with a function command of the display device, the functions comprising change view of media in album and change view to another album.

2. The electronic device of claim 1, wherein the motion detector is configured to recognize pre-determined control motions of the electronic device, the pre-determined control motions comprises a first control motion, a second control motion, a third control motion, and a fourth control motion; the view control module controls the display unit to display a next media if the motion of the electronic device is the first control motion, controls the display unit to display a previous media if the motion of the electronic device is the second control motion, controls the display unit to display a media of a next album if the motion of the electronic device is the third control motion, and controls the display unit to display a media of a previous album if the motion of the electronic device is the fourth control motion.

3. The electronic device of claim 2, wherein the first control motion is rotate the electronic device toward user' right about a vertical axis, the second control motion is rotate the electronic device toward user's left about the vertical axis, the third control motion is rotate top of the electronic device away from user about a horizontal axis of the electronic device, and the fourth control motion is rotate top of the electronic device toward user about the horizontal axis.

4. The electronic device of claim 2, wherein the first control motion is a sudden short movement of the electronic device along a horizontal axis of the electronic device from right to left, the second control motion is a sudden short movement of the electronic device along the horizontal axis of the electronic device from left to right, the third control motion is a sudden short movement of the electronic device along a vertical axis of the electronic device from down to up, and the fourth control motion is a sudden short movement of the electronic device along the horizontal axis of the electronic device from up to down.

5. The electronic device of claim 2, wherein the view control module controls the display unit to display a first media of the previous album or of the next album if the motion of the electronic device is the third control motion or the fourth control motion.

6. The electronic device of claim 2, wherein the view control module controls the display unit to display a random media of the previous album or of the next album on the display unit if the motion of the electronic device is the third control motion or the fourth control motion.

7. The electronic device of claim 1, wherein the electronic device is selected from the group consisting of an e-reader, a mobile phone, and a digital photo frame.

8. The electronic device of claim 1, wherein the displayable media are digital pictures which are contained in two or more albums.

9. A method adapted for an electronic device for viewing displayable medias, the method comprising:
detecting motions of the electronic device;
determining the motion of the electronic device is a first two control motion or a second two control motion;
controlling a display unit to display a next media or a previous media if the motion of the electronic device is a first two control motion; and
controlling the display unit to display a media of a next album or a previous album if the motion of the electronic device is a second two control motion.

10. The method of claim 9, wherein the step of determining the motion the electronic device is a first two control motion or a second two control motion comprises:
determining the electronic device is rotated about vertical axis or is rotated about horizontal axis.

11. The method of claim 9, wherein the step of determining the motion the electronic device is a first two control motion or a second two control motion comprises:
determining the motion of the electronic device is a sudden short movement along the horizontal axis or is a sudden short movement along the vertical axis.

12. The method of claim 9, wherein the step of controlling the display unit to display a next media or a previous media if the motion of the electronic device is the first two control motion comprises:
controlling the display unit to display the next media if the control motion is rotate the electronic device toward user's right about the vertical axis; and
controlling the display unit to display the previous media if the control motion is rotate the electronic device toward the user's left about the vertical axis.

13. The method of claim 9, wherein the step of controlling the display unit to display a media of a next album or a previous album if the motion of the electronic device is the second two control motion comprises:
controlling the display unit to display a media of the next album if the motion of the electronic device is rotate top of the electronic device away from the user about horizontal axis; and
controlling the display unit to display a media of the previous album if the motion of the electronic device is rotate top of the electronic device toward the user about the horizontal axis.

14. The method of claim 9, wherein the step of controlling the display unit to display a next media or a previous media if the motion of the electronic device is the first two control motion comprises:
controlling the display unit to display the next media if the motion of the electronic device is a sudden short movement from right to left along the horizontal axis; and
controlling the display unit to display the previous media if the motion of the electronic device is a sudden short movement from left to right along the horizontal axis.

15. The method of claim 9, wherein the step of controlling the display unit to display a media of a next album or a previous album if the motion of the electronic device is the second two control motion comprises:
controlling the display unit to display a media of the next album if the motion of the electronic device is a sudden short movement from down to up along the vertical axis; and
controlling the display unit to display a media of the previous media if the motion of the electronic device is a sudden short movement from up to down along the vertical axis.

16. The method of claim 9, wherein the step of controlling the display unit to display a media of a next album or a previous album if the motion of the electronic device is the second two control motion comprises:
controlling the display unit to display a first media of the next album or the previous album.

17. The method of claim 9, wherein the step of controlling the display unit to display a media of a next album or a previous album if the motion of the electronic device is the second two control motion comprises:
controlling the display unit to display a random media of the next album or the previous album.
